(19) United States
(12) Patent Application Publication
(10) Pub. No.: US 2014/0030012 A1
(43) Pub. Date: Jan. 30, 2014

(54) LOCATING DEVICE FOR SLIDE JOINT

(71) Applicant: YU CHIEH LEE, TAINAN (TW)

(72) Inventor: YU CHIEH LEE, TAINAN (TW)

(21) Appl. No.: 13/558,944

(22) Filed: Jul. 26, 2012

(51) Int. Cl. F16B 21/00

(52) U.S. Cl. 403/326

(57) ABSTRACT

A locating device for slide joint is mounted to an inner member provided with at least one locating hole and an outer member provided with a through hole and slidably fitted on the inner member. The locating device includes a mounting seat mounted on the outer member; a pushbutton pivotally connected to the mounting seat and having an engaging section located at an end thereof; a torsion spring arranged between the pushbutton and the mounting seat to apply a constant torque on the pushbutton; and a locating rod having two spaced annular ribs. The engaging section of the pushbutton is located between the two annular ribs to selectively press against one of the two inner annular ribs under the torque of the torsion spring. The locating rod has an inner end extended through the through hole on the outer member to insert into the locating hole on the inner member.

### FIELD OF THE INVENTION

The present invention relates to a locating device for slide joint.

### BACKGROUND OF THE INVENTION

A locating device can be used to releasably lock two slidably connected members in a variety of applications, such as being used on a telescopic pipe or between a pipe and a sliding sleeve mounted on around the pipe. The conventional locking device for the telescopic pole of tent frame includes an inner pipe and an outer pipe, both of which have a locating hole formed thereon. A locating seat is fixedly mounted on around the outer pipe, and a pushbutton is pivotally connected at a middle section to the locating seat. The pushbutton has an end provided with a locating pin, and another end pressed against a return spring. The locating pin is aligned with the locating hole on the outer pipe. To deploy the tent frame, first pull the inner pipe from the outer pipe. When the locating pin is also aligned with the locating hole on the inner pipe, the return spring automatically pushes the locating pin into the locating hole on the inner pipe to achieve the purpose of automatic locking of the inner pipe to the outer pipe. The above locking device has the following drawbacks: (1) since the pushbutton is pivotally connected at an end to the locating pin, the locking device could not be conveniently assembled and has short service life; and (2) with the other end of the pushbutton pressed against the return spring, the return spring tends to displace during the use of the locking device; and the displaced return spring will change the direction of its spring force to thereby possibly cause error movement of the pushbutton to lose the function of automatic locating of the inner pipe to the outer pipe.

### SUMMARY OF THE INVENTION

A primary object of the present invention is to provide a locating device for slide joint in order to overcome the drawbacks in conventional locating device for slide joint.

To achieve the above and other objects, the locating device for slide joint according to an embodiment of the present invention is mounted to two slidably connected members, including an inner member and an outer member slidably fitted on around the inner member, the outer member is provided with a through hole and the inner member is provided with at least one locating hole. The locating device includes a mounting seat fixedly mounted on the outer member; a pushbutton pivotally connected to the mounting seat and having an engaging section located at an end thereof; a torsion spring arranged between the pushbutton and the mounting seat to apply a constant torque on the pushbutton; and a locating rod having two spaced annular ribs. The engaging section of the pushbutton is engaged with the locating rod to locate between the two annular ribs, and is selectively pressed against one of the two inner annular ribs under the torque of the torsion spring. And, the locating rod has an inner end extended through the through hole on the outer member into the locating hole on the inner member.

In a preferred embodiment, the pushbutton is pivotally connected at a middle section to the mounting seat.

In a preferred embodiment, the two annular ribs of the locating rod includes an outer annular rib and an inner annular rib; and the engaging section of the pushbutton is selectively pressed against the inner annular rib or pushed against the outer annular rib.

In a preferred embodiment, the engaging section located at one end of the pushbutton defines an opening communicating with the end surface of the pushbutton, and an edge of the opening is selectively pressed against the inner annular rib or pushed against the outer annular rib.

In a preferred embodiment, the mounting seat is provided with a through hole, and the inner end of the locating rod is sequentially extended through the through hole on the mounting seat and the through hole on the outer member into the locating hole on the inner member.

In a preferred embodiment, the inner annular rib has an inner side surface rest on the mounting seat.

In a preferred embodiment, the inner member and the outer member together form a telescopic pipe.

In a preferred embodiment, the outer member is a slidable joint.

In a preferred embodiment, the inner member is provided with multiple locating holes, and the inner end of the locating rod is extended through the through hole of the outer member to insert into one of the locating holes.

With the above arrangements, the locating device for slide joint according to the present invention provides the beneficiary effect that the engaging section of the pushbutton, due to the torque of the torsion spring, automatically presses against the inner annular rib for the inner end of the locating rod to extend through the through hole on the outer member and insert into one locating hole on the inner member without the drawbacks of the prior art locating device for slide joint. The locating device of the present invention also has the following advantages: (1) since the pushbutton acts on the locating rod by pressing the engaging section against the annular ribs on the locating rod, the pushbutton and the locating rod can be separately fabricated and then easily and quickly assembled to each other to reduce the manufacturing cost of the locating device; and (2) the use of the torsion spring can produce constant rotational torque, which enables accurate and reliable automatic alignment of the locating rod with the through hole and locating hole to avoid the risk of failing to lock the outer and inner members together by the locating rod due to changed direction of the elastic force. And, since the edge of the opening of the engaging section communicates with the end surface of the pushbutton and can be selectively pressed against the inner annular rib or pushed against the outer annular rib, the locating device can be quickly and reliably assembled.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view showing the locating device according to a first embodiment of the present invention is used with a tent frame;

FIG. 2 is an enlarged exploded perspective view of the circled area A of FIG. 1;

FIG. 3 is an enlarged assembled sectional side view of the circled area A of FIG. 1;

FIG. 4 is a perspective view showing the locating device according to a second embodiment of the present invention is used with a folding bed frame;

FIG. 5 is an enlarged exploded perspective view of the circled area B of FIG. 4;

FIG. 6 is an enlarged assembled sectional side view of the circled area B of FIG. 4;

FIG. 7 is a perspective view showing the locating device according to a third embodiment of the present invention is used with a foldable table frame;

FIG. 8 is an enlarged exploded perspective view of the circled area C of FIG. 7; and

FIG. 9 is an enlarged assembled sectional side view of the circled area C of FIG. 7.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

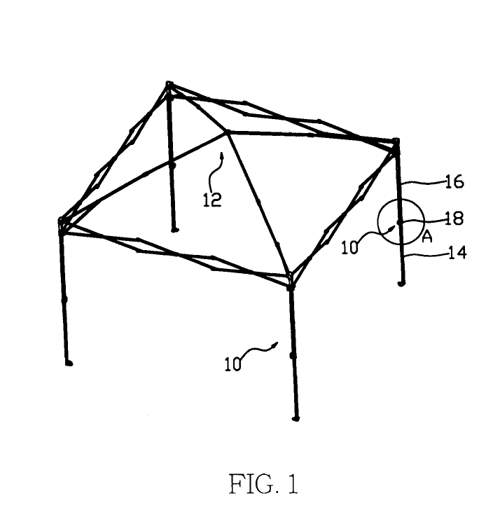

Please refer to FIG. 1. A tent frame includes four telescopic poles 10 and a canopy frame 12 assembled to a top of the four telescopic poles 10. Each of the telescopic poles 10 includes an inner pipe 14, an outer pipe 16 slidably fitted on around and connected to the inner pipe 14, and a locating device 18 for locating the outer pipe 16 to a position relative to the inner pipe 14.

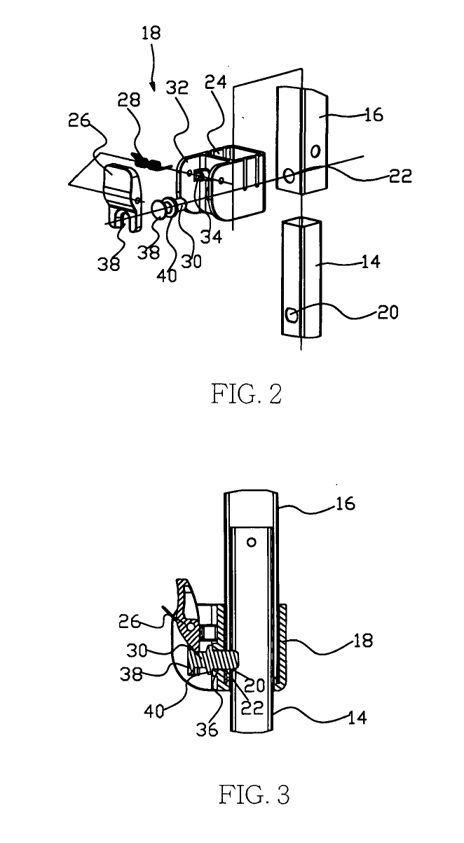

Please refer to FIGS. 2 and 3. The inner pipe 14 is provided on one side with multiple axially spaced locating holes 20. The outer pipe 16 is correspondingly provided on one side with a through hole 22.

As can be seen in FIGS. 2 and 3, a first embodiment of the locating device 18 for use with the telescopic pole 10 includes a mounting seat 24, a pushbutton 26, a torsion spring 28, and a locating rod 30.

The mounting seat 24 is fixedly mounted to an outer side of the outer pipe 16; and includes two forward extended lugs 32, two insertion holes 34, and a through hole 36.

The pushbutton 26 has a middle section located in between the two lugs 32 of the mounting seat 24. A pivot shaft (not shown) is extended through the two lugs 32 and the middle section of the pushbutton 26, so that the pushbutton 26 is pivotally connected to the mounting seat 24 via the pivot shaft. The pushbutton 26 further includes an engaging section 38 located at an end thereof. The engaging section 38 defines an opening communicating with the end surface of the pushbutton 26.

The torsion spring 28 is fitted around the pivot shaft with two ends separately inserted in the two insertion holes 34, which are provided on the two lugs 32, such that the pushbutton 26 is subjected to a constant rotational torque.

The locating rod 30 is provided with an outer annular rib 38 and an inner annular rib 40.

The opening defined by the engaging section 38 of the pushbutton 26 is engaged with the locating rod 30 to locate between the outer annular rib 38 and the inner annular rib 40. An edge of the opening defined by the engaging section 38 can be selectively pressed against an outer side surface of the inner annular rib 40 or pushed against an inner side surface of the outer annular rib 38.

When the locating device 18 is in a locked position, the edge of the opening of the engaging section 38 is pressed against the outer side surface of the inner annular rib 40 under the torque of the torsion spring 28, and an inner end of the locating rod 30 is sequentially extended through the through hole 36 on the mounting seat 24 and the through hole 22 on the outer pipe 16 to insert into one of the locating holes 20 on the inner pipe 14. Meanwhile, the inner side surface of the inner annular rib 40 is rest around the through hole 36 of the mounting seat 24 to prevent the locating rod 30 from being too deeply inserted into the inner pipe 14. By inserting the locating rod 30 into different locating holes 20 on the inner pipe 14, it is able to set the telescopic pole 10 to different overall height.

To unlock the locating device 18, simply push against another end of the pushbutton 26 opposite to the engaging section 38 in order to overcome the torque of the torsion spring 28, and the edge of the opening defined by the engaging section 38 is brought to push against the inner side surface of the outer annular rib 38 to thereby move the locating rod 30 outward to disengage the inner end of the locating rod 30 from the locating hole 22. At this point, the locating device 18 is in a released position, allowing a user to freely adjust the length of the telescopic pole 10 by sliding the outer pipe 16 upward or downward relative to the inner pipe 14. When the outer pipe 16 has been adjusted to a desired position, simply release the pushbutton 26 and the edge of the opening of the engaging section 38 will press against the inner annular rib 38 again under the torque of the torsion spring 28. At this point, the inner end of the locating rod 30 sequentially extends through the through hole 36 on the mounting seat 24 and the through hole 22 of the outer pipe 16 to insert into one selected locating hole 20.

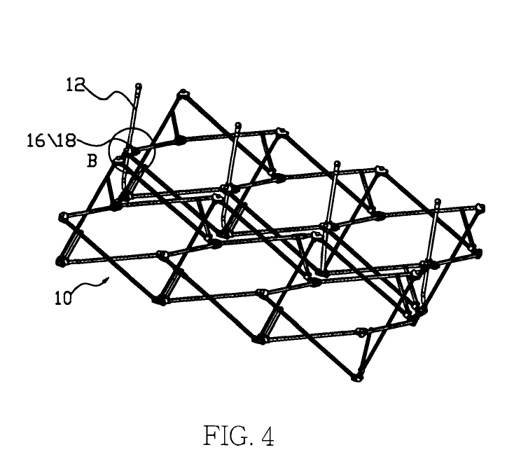

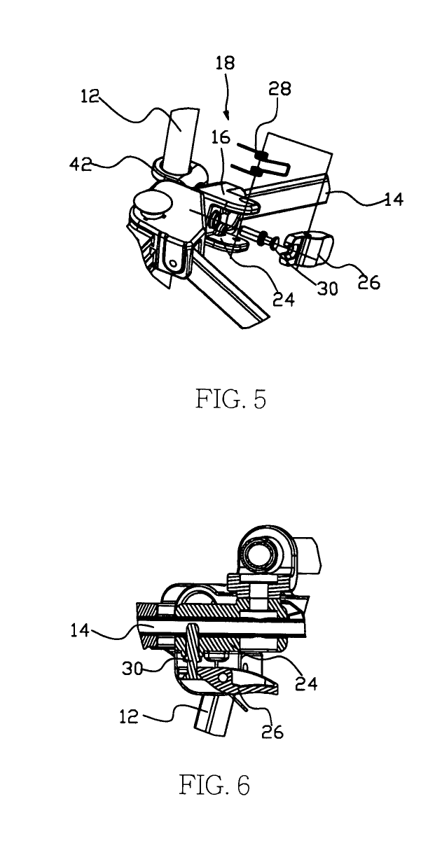

FIG. 4 shows a folding bed frame that can be converted into a sofa according to actual need. Chinese Utility Patent entitled “Sofa-convertible Folding Bed and Bed Frame Thereof” granted to the same applicant can be referred to for the detailed description of the structure of the folding bed frame. The folding bed frame includes a foldable support frame 10 and four backrest poles 12 spaced along a longitudinal direction of the support frame 10. Please also refer to FIGS. 5 and 6. Each of the backrest poles 12 has a connector provided thereon. The connector includes a first slidable joint 42 and a second slidable joint 16, which are pivotally connected to each other. The backrest pole 12 has a lower end pivotally connected to a lower portion of a first pipe of a rear scissor linkage, and an upper end slidably extended through the first slidable joint 42. The second slidable joint 16 is slidably fitted on around an upper portion of a second pipe 14 of the rear scissor linkage. A locating device 18 according to a second embodiment of the present invention is provided between the second pipe 14 and the second slidable joint 16.

As can be seen in FIGS. 5 and 6, the second pipe 14 is formed with a locating hole 20, and the second slidable joint 16 is provided with a through hole.

The locating device 18 includes a mounting seat 24, a pushbutton 26, a torsion spring 28, and a locating rod 30.

The mounting seat 24 is integrally formed on an outer side of the second slidable joint 16; and includes two forward extended lugs, two insertion holes, and a through hole 36. The through hole 36 of the mounting seat 24 is also the through hole formed on the second slidable joint 16.

The pushbutton 26 has a middle section located in between the two lugs 32 of the mounting seat 24. A pivot shaft (not shown) is extended through the two lugs 32 and the middle section of the pushbutton 26, so that the pushbutton 26 is pivotally connected to the mounting seat 24 via the pivot shaft. The pushbutton 26 further includes an engaging section 38 located at an end thereof. The engaging section 38 defines an opening communicating with the end surface of the pushbutton 26.

The torsion spring 28 is fitted around the pivot shaft with two ends separately inserting into the two insertion holes 34, which are provided on the two lugs 32, such that the pushbutton 26 is subjected to a constant rotational torque.

The locating rod 30 is provided with an outer annular rib 38 and an inner annular rib 40.

The opening defined by the engaging section 38 of the pushbutton 26 is engaged with the locating rod 30 to locate between the outer annular rib 38 and the inner annular rib 40. An edge of the opening defined by the engaging section 38 can be selectively pressed against an outer side surface of the inner annular rib 40 or pushed against an inner side surface of the outer annular rib 38.

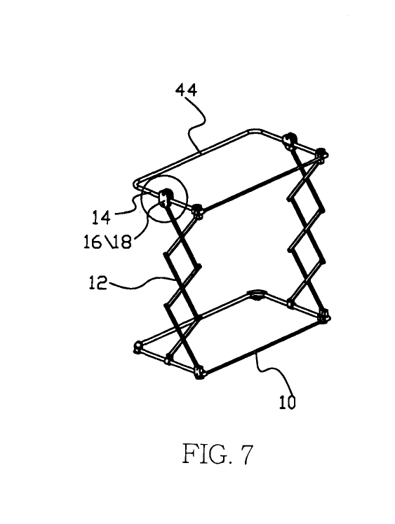

FIG. 7 shows a foldable table frame that includes a base frame 10, a table top frame 44, and two spaced sets of scissor linkages 12 separately connected to between the base frame 10 and the table top frame 44. Each set of scissor linkages 12 includes multiple serially pivotally connected scissor linkages. One of the two lowermost ends of each set of scissor linkages 12 is pivotally connected to the base frame 10, while the other lowermost end is slidably connected to the base frame 10. One of the two uppermost ends of each set of scissor linkages 12 is pivotally connected to the table top frame 44, while the other uppermost end is provided with a slidable joint 16. The slidable joint 16 is slidably connected to a side pipe 14 of the table top frame 44. A locating device 18 according to a third embodiment of the present invention is connected to between the slidable joint 16 and the side pipe 14. When the locating device 18 is in a locked position, the slidable joint 16 is immovably connected to the side pipe 14 to maintain the foldable table frame in a fully deployed state. When the locating device 18 is unlocked, the foldable table frame can be freely folded.

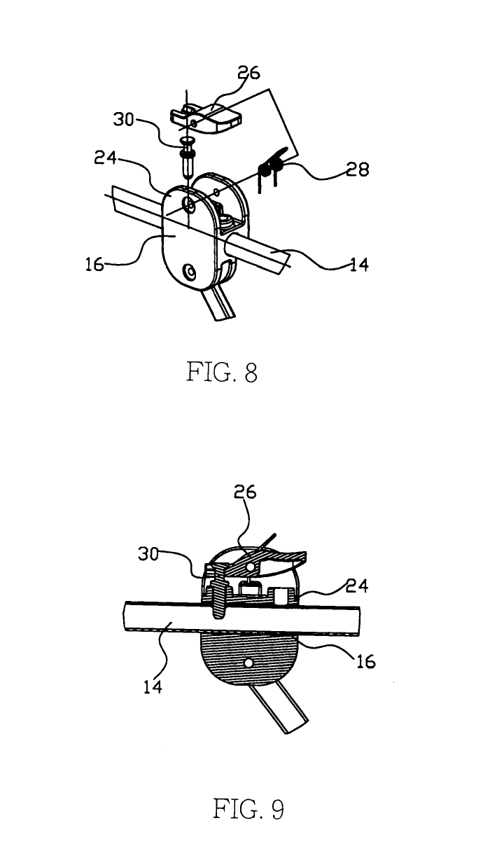

As can be seen in FIGS. 8 and 9, the side pipe 14 is formed with a locating hole 20, and the slidable joint 16 is provided with a through hole.

The locating device 18 includes a mounting seat 24, a pushbutton 26, a torsion spring 28, and a locating rod 30.

The mounting seat 24 is integrally formed on an outer side of the slidable joint 16; and includes two forward extended lugs, two insertion holes, and a through hole 36. The through hole 36 of the mounting seat 24 is also the through hole formed on the slidable joint 16.

The pushbutton 26 has a middle section located in between the two lugs 32 of the mounting seat 24. A pivot shaft (not shown) is extended through the two lugs 32 and the middle section of the pushbutton 26, so that the pushbutton 26 is pivotally connected to the mounting seat 24 via the pivot shaft. The pushbutton 26 further includes an engaging section 38 located at an end thereof. The engaging section 38 defines an opening communicating with the end surface of the pushbutton 26.

The torsion spring 28 is fitted around the pivot shaft with two ends separately inserting into the two insertion holes 34, which are provided on the two lugs 32, such that the pushbutton 26 is subjected to a constant rotational torque.

The locating rod 30 is provided with an outer annular rib 38 and an inner annular rib 40.

The opening defined by the engaging section 38 of the pushbutton 26 is engaged with the locating rod 30 to locate between the outer annular rib 38 and the inner annular rib 40. An edge of the opening defined by the engaging section 38 can be selectively pressed against an outer side surface of the inner annular rib 40 or pushed against an inner side surface of the outer annular rib 38.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A locating device for slide joint, being mounted to two slidably connected members, the two members including an inner member and an outer member slidably fitted on around the inner member, the outer member being provided with a through hole and the inner member being provided with at least one locating hole; comprising:
a mounting seat being fixedly mounted on the outer member;
a pushbutton being pivotally turnably connected to the mounting seat and having an engaging section located at an end thereof;
a torsion spring being arranged between the pushbutton and the mounting seat, such that the pushbutton is subjected to a constant rotational torque of the torsion spring; and
a locating rod being provided with two spaced annular ribs;
wherein the engaging section of the pushbutton is engaged with the locating rod to locate between the two annular ribs, and is selectively pressed against one of the two inner annular ribs under the torque of the torsion spring; and the locating rod has an inner end extended through the through hole on the outer member to insert into the locating hole on the inner member.

2. The locating device for slide joint as claimed in claim 1, wherein the pushbutton is pivotally connected at a middle section to the mounting seat.

3. The locating device for slide joint as claimed in claim 1, wherein the two annular ribs of the locating rod includes an outer annular rib and an inner annular rib; and the engaging section of the pushbutton being selectively pressed against the inner annular rib or pushed against the outer annular rib.

4. The locating device for slide joint as claimed in claim 3, wherein the engaging section located at one end of the pushbutton defines an opening communicating with the end surface of the pushbutton, and an edge of the opening being selectively pressed against the inner annular rib or pushed against the outer annular rib.

5. The locating device for slide joint as claimed in claim 3, wherein the mounting seat is provided with a through hole, and the inner end of the locating rod being sequentially extended through the through hole on the mounting seat and the through hole on the outer member to insert into the locating hole on the inner member.

6. The locating device for slide joint as claimed in claim 5, wherein the inner annular rib has an inner side surface rest on the mounting seat.

7. The locating device for slide joint as claimed in claim 1, wherein the inner member and the outer member together form a telescopic pipe.

8. The locating device for slide joint as claimed in claim 1, wherein the outer member is a slidable joint.

9. The locating device for slide joint as claimed in claim 1, wherein the inner member is provided with multiple locating holes, and the inner end of the locating rod being extended through the through hole of the outer member to insert into one of the locating holes.
